(19) United States
(12) Patent Application Publication
(10) Pub. No.: US 2014/0167720 A1
(43) Pub. Date: Jun. 19, 2014

(54) POWER CONTROL DEVICE WITH SNUBBER CIRCUIT

(71) Applicant: HON HAI PRECISION INDUSTRY CO., LTD., New Taipei (TW)

(72) Inventor: CHENG-LUNG CHIANG, New Taipei (TW)

(73) Assignee: HON HAI PRECISION INDUSTRY CO., LTD., New Taipei (TW)

(21) Appl. No.: 13/945,877

(22) Filed: Jul. 18, 2013

(30) Foreign Application Priority Data
Dec. 14, 2012 (TW) 101147428

(51) Int. Cl. H02M 3/156

(52) U.S. Cl. CPC H02M 3/156
USPC 323/282

(57) ABSTRACT

An energy-efficient power control device, which employs a snubber circuit only during the risk of voltage spikes during fast switching, includes a buck converter, a power supply unit (PSU), a peak detecting circuit, a snubber circuit, and a logic circuit. The power control device supplies power to an input terminal of an electronic device. The snubber circuit is connected to the buck converter. The logic circuit is connected between the peak detecting circuit and the snubber circuit and determines whether the buck converter is under the heavy load or a light load according to the voltage, and connects the snubber circuit when the buck converter is under the heavy load, and disconnects the snubber circuit when the buck converter is under the light load.

### BACKGROUND

1. Technical Field

The disclosure generally relates to power control devices, and more particularly, to a power control device including a snubber circuit.

2. Description of the Related Art

A typical power control device of electronic devices includes a power supply unit (PSU) and a buck converter. The PSU supplies direct current (DC). The buck converter converts the DC voltage of the PSU down to one or more preset voltages which may be supplied to the electronic device. A typical buck converter includes a first switch and a second switch alternately closing and opening. When the buck converter is under a heavy load (for example, when the output voltage of the PSU is high (e.g., greater than 20 volts)), the first switch and the second switch turn on and turn off at a high frequency which would result in generation of a voltage spike that may damage the first switch and the second switch.

A commonly used snubber circuit includes a resistor and a capacitor connected in series, and the snubber circuit is connected in parallel with the second switch to decrease the voltage spike. However, when the buck converter is under a light load (for example, when the output voltage of the PSU is low (e.g., less than 10 volts), the snubber circuit is idle and increases power loss of the power control device.

Therefore, there is room for improvement within the art.

### BRIEF DESCRIPTION OF THE DRAWINGS

Many aspects of an exemplary power control device can be better understood with reference to the following drawings. The components in the drawings are not necessarily drawn to scale, the emphasis instead being placed upon clearly illustrating the principles of the exemplary power control device. Moreover, in the drawings, like reference numerals designate corresponding parts throughout the several views. Wherever possible, the same reference numbers are used throughout the drawings to refer to the same or like elements of an embodiment.

FIG. 1 is a circuit diagram of a power control device, according to an exemplary embodiment.

FIG. 2 is a circuit diagram of a peak detecting circuit of the power control device of FIG. 1.

### DETAILED DESCRIPTION

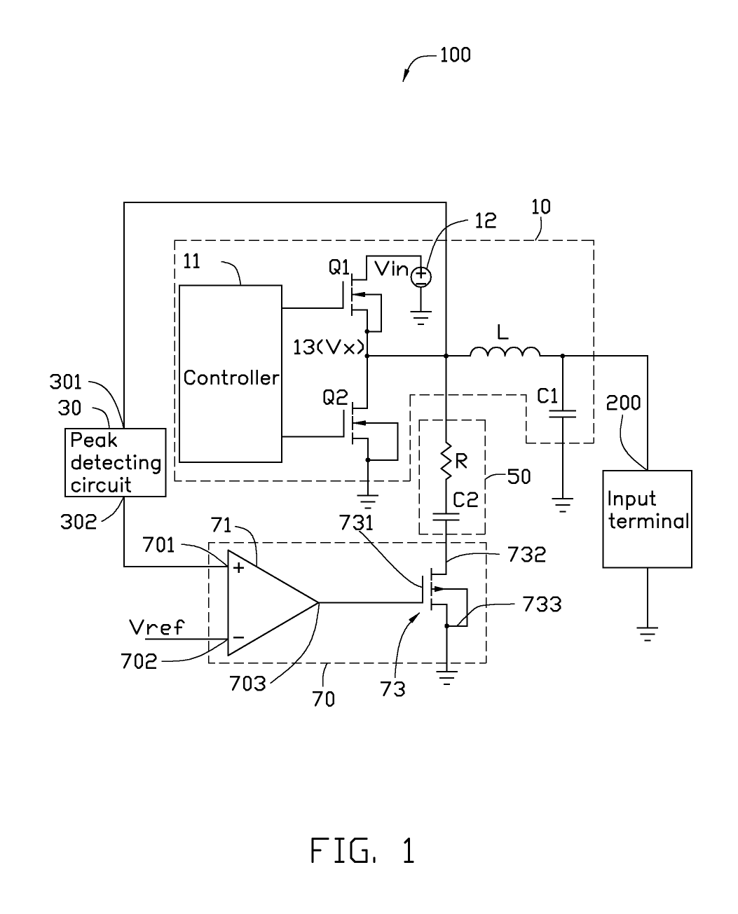

FIG. 1 is a circuit of power control device 100 of one embodiment. The power control device 100 supplies power to an input terminal 200 of an electronic device (not shown). The power control device 100 includes a buck converter 10, a power supply unit (PSU) 12, a peak detecting circuit 30, a snubber circuit 50, and a logic circuit 70. The PSU 12 provides a direct current voltage Vin to the buck converter 10. The buck converter 10 includes a controller 11 which is utilized to output a stable working voltage for the input terminal 200. The peak detecting circuit 30 is electronically connected between the buck converter 10 and the logic circuit 70. The peak detecting circuit 30 detects a voltage Vx of the buck converter 10. The buck converter 10 provides the voltage Vx to a load (not shown) of the input terminal 200. The voltage Vx varies with the load presented by the input terminal 200. For example, if the load of the input terminal 200 becomes greater, the voltage Vx must become greater to make sure that the input terminal 200 is in a normal working state.

The snubber circuit 50 is electrically connected to the buck converter 10. The logic circuit 70 is electrically connected to the snubber circuit 50 and defines a reference voltage value Vref. The logic circuit 70 compares the reference voltage value Vref with the voltage Vx detected by the peak detecting circuit 30 to generate a comparison and controls the snubber circuit 50 to work or to stop working based on the result of the comparison.

When the peak detecting circuit 30 detects that the voltage Vx is high, the logic circuit 70 determines that the buck converter 10 is under a heavy load and controls the snubber circuit 50 to work so as to protect the buck converter 10. When the peak detecting circuit 30 detects that the voltage Vx is low, the logic circuit 70 determines that the buck converter 10 is under a light load and controls the snubber circuit 50 to stop working so as to cancel the drain of power taken by the snubber circuit 50 itself.

The buck converter 10 includes the controller 11, a first switch Q1, a second switch Q2, an inductor L, and a filter capacitor C1. In this embodiment, the first switch Q1 and the second switch Q2 are field-effect transistors. Gate electrodes of the first switch Q1 and the second switch Q2 are electronically connected to the controller 11. The controller 11 adjusts voltages of the gate electrodes to selectively close or open the first switch Q1 and the second switch Q2. In this embodiment, the controller 11 is a pulse width modulation integrated circuit (PWM IC) chip. The controller 11 sends pulse width modulation signals to the first switch Q1 and the second switch Q2, and adjusts duty ratio of the pulse width modulation signals to regulate turn-on times of the first switch Q1 and the second switch Q2.

The first switch Q1 and the second switch Q2 are connected in series between the PSU 12 and the ground to obtain a node 13 between the first switch Q1 and the second switch Q2, and a voltage of the node 13 is equal to the voltage Vx. A drain electrode of the first switch Q1 is electronically connected to the PSU 12, and a source electrode of the first switch Q1 is electronically connected to a drain of the second switch Q2. A source electrode of the second switch Q2 is grounded. A first end of the inductor L is electronically connected to the drain electrode of the second switch Q2, and a second end of the inductor L is electronically connected to ground through the filter capacitor C1. The input terminal 200 is connected in parallel with the filter capacitor C1.

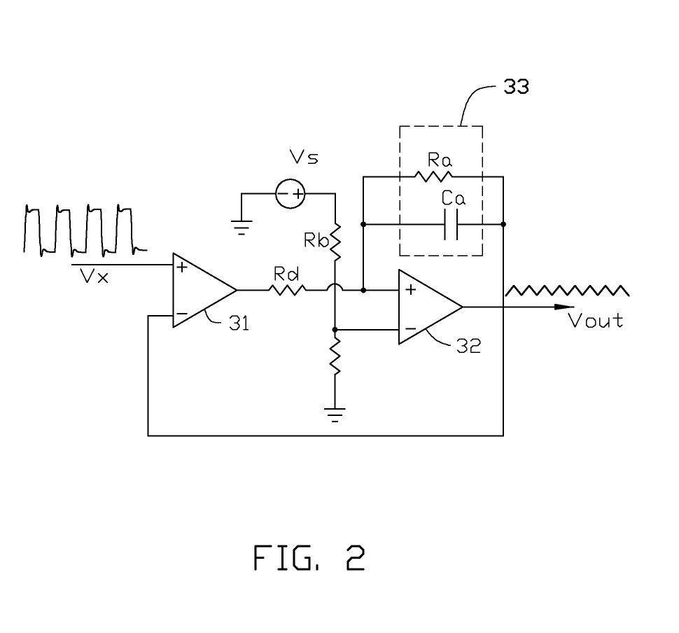

When the controller 11 allows the first switch Q1 to close (turn on), and allows the second switch Q2 to open (turn off), the PSU 12 provides power to the input terminal 200 via the first switch Q1 and the inductor L, and the inductor L stores electromagnetic energy. When the controller 11 allows the first switch Q1 to open (turn off), and allows the second switch Q2 to close (turn on), the inductor L acts like a voltage source and provides power to the input terminal 200. Therefore, the first switch Q1 alternately opens or closes and the voltage Vx is generated as PWM signals as shown in FIG. 2.

The peak detecting circuit 30 defines a detecting terminal 301 and an output terminal 302. The detecting terminal 301 is electrically connected to the node 13 of the buck converter 10 and is utilized to detect the voltage Vx. The output terminal 302 is electrically connected to the logic circuit 70. As shown in FIG. 2, the peak detecting circuit 30 converts the voltage Vx having an irregular waveform into an output voltage Vout having a sawtooth and more regular waveform and the output terminal 302 outputs the output voltage Vout.

In the embodiment, a time difference between peaks of the sawtooth waveform is very small and the output voltage Vout is similar to a smooth and constant voltage. In other words, the peak detecting circuit 30 converts the voltage Vx into a DC voltage Vout, the DC voltage Vout is proportional to the peak value of the voltage Vx, therefore, as the peak value of the voltage Vx becomes greater, the output voltage Vout also becomes greater. The logic circuit 70 compares the output voltage Vout with the reference voltage value Vref to determine whether the buck converter 10 is under a heavy load or the light load.

Referring to FIG. 2, the peak detecting circuit 30 includes a follower 31, an amplifier 32, and an RC circuit 33. The RC circuit 33 is an integral circuit. The RC circuit 33 is composed of a resistor Ra and a capacitor Ca connected in parallel. The follower 31 tracks the voltage Vx to be integrated within the RC circuit 33 and outputs the sawtooth waveform voltage Vout to the logic circuit 70.

The snubber circuit 50 includes a resistor R and a snubber capacitor C2 connected in series. The drain electrode of the second switch Q2 is connected to the resistor R. The snubber capacitor C2 is connected to ground via the logic circuit 70.

The logic circuit 70 includes a comparator 71 and a control switch 73. The comparator 71 includes a first input terminal 701, a second input terminal 702, and an output terminal 703. The control switch 73 includes a control terminal 731, a first open terminal 732, and a second open terminal 733. The first input terminal 701 is electrically connected to the output terminal 302 of the peak detecting circuit 30. The second input terminal 702 is electrically connected to the reference voltage Vref. The output terminal 703 is electrically connected to the control terminal 731. The first open terminal 732 is electrically connected to the snubber capacitor C2 and the second open terminal 733 is grounded.

The comparator 71 compares the output voltage Vout of the peak detecting circuit 30 with the reference voltage Vref. When the output voltage Vout of the peak detecting circuit 30 is greater than the reference voltage Vref, the comparator 71 controls the control switch 73 to close, and the snubber circuit 50 is activated and works to protect the buck converter 10. When the output voltage Vout of the peak detecting circuit 30 is less than the reference voltage Vref, the comparator 71 controls the control switch 73 to open, and the snubber circuit 50 is cut off and stops working to avoid power being consumed by the snubber circuit 50.

In the embodiment, the first input terminal 701 is a normal phase one and the second input terminal 702 is an abnormal phase one. The control switch 73 is a NMOS transistor. When the output voltage Vout of the peak detecting circuit 30 is greater than the reference voltage Vref, the buck converter 10 is under the heavy load, and the comparator 71 outputs a high level signal and controls the control switch 73 to close. When the output voltage Vout of the peak detecting circuit 30 is less than the reference voltage Vref, the buck converter 10 is under the light load, and the comparator 71 outputs a low level signal and controls the control switch 73 to open.

The working process of the power control device 100 is described as below. The PSU 12 provides the input voltage Vin to the buck converter 10, and then the controller 11 sends PWM signals to the first switch Q1 and the second switch Q2 to selectively close or open the first switch Q1 and the second switch Q2. The peak detecting circuit 30 detects the voltage Vx, and the logic circuit 70 compares the voltage Vx with the reference voltage Vref. If the voltage Vx is greater than the reference voltage Vref, the buck converter 10 is deemed to be under the heavy load. The peak detecting circuit 30 triggers the comparator 71 to close the control switch 73. Thus, the snubber circuit 50 is connected in parallel with the second switch Q2 to decrease and protect against any voltage spike of the voltage Vx. If the voltage Vx is less than the reference voltage Vref, the buck converter 10 is deemed to be under the light load. The peak detecting circuit 30 triggers the comparator 71 to open the control switch 73 and thus disconnect the snubber circuit 50. Thus, the snubber circuit 50 is disconnected from the second switch Q2 and power loss is avoided.

The peak detecting circuit 30 determines whether the buck converter 10 is under the heavy load or the light load. If the buck converter 10 is under the heavy load, the peak detecting circuit 30 triggers the comparator 71 to allow the snubber circuit 50 to connect in parallel with the second switch Q2, to decrease any voltage spike. If buck converter 10 is under the light load, the peak detecting circuit 30 triggers the comparator 71 to allow the snubber circuit 50 to be disconnected from the second switch Q2 and the power drain represented by the snubber circuit 50 is avoided.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A power control device configured to supply power to an input terminal of an electronic device, the power control device comprising:
a buck converter to convert a direct current voltage into a preset voltage for the input terminal;
a power supply unit to provide the direct current voltage to the buck converter;
a peak detecting circuit to detect a voltage of the buck converter and convert the voltage into an output voltage;
a snubber circuit connected to the buck converter and to protect the buck converter when the buck converter is under a heavy load; and
a logic circuit connected between the peak detecting circuit and the snubber circuit and to determine whether the buck converter is under the heavy load or a light load according to the detected voltage, to control the snubber circuit to work when the buck converter is under the heavy load, and to control the snubber circuit to stop working when the buck converter is under the light load.

2. The power control device as claimed in claim 1, wherein the peak detecting circuit is further configured to convert the voltage having an irregular waveform into the output voltage having a regular sawtooth waveform.

3. The power control device as claimed in claim 2, wherein the peak detecting circuit comprises a follower, an amplifier, and an RC circuit, the RC circuit is an integral circuit and is composed of a resistor and a capacitor connected in parallel, and the follower tracks the voltage to integrate via the RC circuit and outputs the output voltage to the logic circuit.

4. The power control device as claimed in claim 2, wherein the logic circuit defines a reference voltage and compares the output voltage with the reference voltage, when the output voltage is greater than the reference voltage, the buck converter is under the heavy load; and when the output voltage is less than the reference voltage, the buck converter is under the light load.

5. The power control device as claimed in claim 2, wherein the logic circuit defines a reference voltage and comprises a comparator and a control switch, the logic circuit is electrically connected to the snubber circuit via the control switch, the comparator compares the output voltage with the reference voltage to generate a comparison and controls the snubber circuit to work or stop working based on the comparison.

6. The power control device as claimed in claim 5, wherein the comparator comprises a first input terminal, a second input terminal, and an output terminal, the control switch comprises a control terminal, a first open terminal, and a second open terminal, the first input terminal is electrically connected to an output terminal of the peak detecting circuit, the second input terminal is electrically connected to the reference voltage, the output terminal is electrically connected to the control terminal, and the first open terminal is electrically connected to the snubber circuit and the second open terminal is grounded.

7. The power control device as claimed in claim 5, wherein the snubber circuit comprises a resistor and a snubber capacitor connected in series, the snubber circuit is electrically connected to the control switch via the snubber capacitor and is electrically connected to the buck converter via the resistor.

8. The power control device as claimed in claim 1, wherein the buck converter comprises a controller, a first switch, a second switch, an inductor, and a filter capacitor, gate electrodes of the first switch and the second switch are electronically connected to the controller, the controller adjusts voltages of the gate electrodes to selectively close or open the first switch and the second switch, the first switch and the second switch are connected in series between the power supply unit and the ground to generate a node between the first switch and the second switch, and a voltage of the node is equal to the voltage, a drain electrode of the first switch is electronically connected to the power supply unit, and a source electrode of the first switch is electronically connected to a drain of the second switch, a source electrode of the second switch is grounded, a first end of the inductor is electronically connected to the drain electrode of the second switch, and a second end of the inductor is electronically connected to the ground through the filter capacitor, and the input terminal is connected in parallel with the filter capacitor.

9. The power control device as claimed in claim 8, wherein the controller is a pulse width modulation integrated circuit chip, the controller sends pulse width modulation signals to the first switch and the second switch, and adjusts duty ratio of the pulse width modulation signals to regulate turn-on time of the first switch and the second switch.

10. The power control device as claimed in claim 8, wherein when the controller allows the first switch to close, and allows the second switch to open, the power supply unit provides power to the input terminal via the first switch and the inductor, and the inductor stores energy in electromagnetic form, when the controller opens the first switch, and closes the second switch, and the inductor acts like a voltage source and provides power to the input terminal.
